(19) United States
(12) Patent Application Publication
(10) Pub. No.: US 2002/0065918 A1
(43) Pub. Date: May 30, 2002

(54) Method and apparatus for efficient and accountable distribution of streaming media content to multiple destination servers in a data packet network (DPN)

(76) Inventor: Vijnan Shastri, Encinitas, CA (US)

Correspondence Address: CENTRAL COAST PATENT AGENCY, PO BOX 187, AROMAS, CA, 95004, US

(21) Appl. No.: 09/727,965

(22) Filed: Nov. 30, 2000

(51) Int. Cl. G06F 15/173; G06F 15/16

(52) U.S. Cl. 709/226; 709/231; 709/201

(57) ABSTRACT

A system for efficient streaming of media content from a client content provider to individual Internet destinations has an Internet-connected base server for job initialization and tracking; and a matrix of Internet-connected node servers, at least some of which are to receive the streaming media content. The client, the base station and the node servers each execute cooperative software, wherein a client requests a job session of the base server, specifying dimensions of the job, and the base server creates a unique job object defining the job, receives the streaming content from the client, governs distribution of the streaming content to the matrix of node servers according to the job object, and notifies the client content provider of progress and completion. A single client can create multiple job objects to be prosecuted in tandem by the base server, and a base server can handle jobs from multiple clients. Cascaded streaming is supported, including optimization techniques and monitoring a repair of nodes.

### FIELD OF THE INVENTION

The present invention is in the field of video broadcasting and editing, and pertains more particularly to methods and apparatus for distributing media-rich content from a client to multiple destination servers distributed over a Data Packet Network (DPN) for ultimate accessibility by broadband users.

### BACKGROUND OF THE INVENTION

Media distribution over a data-packet-network (DPN) is accomplished between at least two distributed nodes connected to the network. For example, one node, designated as a sending node typically sends content to a second node designated as a receiving node. Any node may be a sending or receiving node depending on the nature and intent of the transaction. A DPN carries data that is organized into data packets, which are addressed from a sending or source node to a receiving or end node by data in fields in a header. A DPN comprises all of the lines, connection points and equipment that make up a communications or data transfer network. A good example of a DPN is the well-known Internet network, which will be used as a preferred example throughout this specification.

Data traffic on the Internet may assume the form of a number of varying media types. Some examples are e-mail, IP telephony, electronic information pages, fax messages, voice message, shared files, and so on. Better techniques for data management and transmission over networks, along with the advent of more powerful processors providing power for connected nodes has recently made transferring video/audio files a practical reality for DPN implementation. The transfer of video/audio content over a DPN is often enhanced with a technique known as multimedia steaming.

Streaming technology involves near real-time data transfer of multimedia files over a data connection or channel set-up between one node and another. Streamed media may be displayed as it downloads and in preferred situations, quality of the media is as good as if downloaded in it's entirety and then played on a display system. Typically, software implemented at both a sending and receiving station in streaming media functions to compress media for sending and to uncompress media for receipt and display of multimedia content. Software media players are provided to enable display of multimedia content wherein the content is audio, video, or a combination thereof.

One problem with current art distribution methods is, that if an error occurs with regard to media receipt at one node, the receiving node must establish a new connection with the source node and begin the download process over again, typically from the beginning. Other problems include managing bandwidth for streaming content. For example, a source server may only transmit at available bandwidth rates supported at the time of transmission. If a dropout occurs there is typically no remedy accept to wait for better bandwidth.

One with skill in the art of media transfer, especially over the Internet, will appreciate that there are now many companies and organizations providing multimedia content to end users. End users typically subscribe to offered services and connect to the Internet for the purpose of receiving streamed content for display on their respective, network-connected nodes.

The technology referred to above wherein video/audio content is streamed to end-users, encompasses a wide range of customer equipment, software, and delivery mediums. For example, users may download streaming content to personal computers connected to the network over standard conventional telephone lines. Special digital services such as Integrated Services Digital Network (ISDN) and Digital Subscriber Lines (DSL) make receiving and playing streamed media more practical through faster connections and greater bandwidth. WEB TV, which typically uses a cable delivery method, is another known implementation of the technology.

In a system known to the inventor, media content is collected, preprocessed and distributed to end servers or nodes distributed on a network from which end users may download media-rich content for display and, in some cases (assuming a back channel), interact with while they are connected to the network. These end servers are adapted to serve video/audio presentations on demand to requesting subscriber/users having suitable network connectivity with their equipment.

It has occurred to the inventors that more and more users are taking advantage of new technologies for receiving interactive video/audio stored for access on such as the Internet, for example. As demand increases, it becomes necessary to provide better and more efficient methods for distributing content from a source or sources to an increasing number of participating media-access nodes or servers.

What is clearly needed is a method and apparatus that enables fast and accountable distribution of multimedia content over a DPN to multiple user-access nodes distributed on the network. A system such as this would allow users more access points from which to receive content and provide accountability to media sources as to success or failure of distribution.

### SUMMARY OF THE INVENTION

In a preferred embodiment of the present invention a system for efficient streaming of media content from a client content provider to individual Internet destinations is provided, comprising an Internet-connected base server for job initialization and tracking; and a matrix of Internet-connected node servers, at least some of which are to receive the streaming media content. The system is characterized in that the client, the base station and the node servers each execute cooperative software, wherein a client requests a job session of the base server, specifying dimensions of the job, and the base server creates a unique job object defining the job, receives the streaming content from the client, governs distribution of the streaming content to the matrix of node servers according to the job object, and notifies the client content provider of progress and completion.

In a preferred embodiment the base server specifies a server list of all servers to which media content is to be streamed as a part of the job object created. Following creation of a job object at the base server, the base server transmits the job object to at least a first one of the node servers, and then streams the job content to the first node server. The base server then transmits the job object to plural ones of the node servers, and streams the job content to the plural node servers.

In preferred embodiments the first node server, having received the job object, becomes a source server, and transmits the job object and streams the job content to further ones of the node servers. If the first node server having the job object attempts to stream the job content to a second node server already receiving streaming job content from a third node server, and the second node server selects between the first and third node servers for receiving streaming job content according to which of the first and third node servers can transmit at a higher rate.

The client content provider, having established a first job object at the base server and having begun streaming job content to the base server, may establish a second job object at the base server for distributing second streamed job content to the node servers. There may also be plural client content providers, wherein the base server establishes job objects for individual ones of the plural client content providers and streams job content for plural job objects to plural downstream nodes simultaneously.

In preferred embodiments of the invention, as each node server completes a job, notification of completion is passed to the base server, which updates the client content provider of progress made. Also in some embodiments, after all node servers have completed a job and have reported to the base server, the base server closes the associated job object and updates the client content provider associated with the job object.

In some embodiments the base server tracks completion of the job by the matrix of node servers, and if the job is not completed by all node servers within a set time, the base server queries the node server or servers failing to complete. Receiving no response from a node server, the base server may attempt to repair the node server not responding.

In another aspect of the invention a method for efficient streaming of media content from a client content provider to individual Internet destinations is provided, comprising steps of (a) requesting, by the client content provider of a base server, creation of a job object defining the job by dimensions supplied by the client content provider; (b) creation, by the base server, the job object requested; (c) receiving, by the base server, streaming job content from the client content provider according to the job object; (d) distributing, by the base server, the job object and streaming job content to individual ones of plural node servers at the Internet destinations; and (e) notifying the client content provider, by the base server, of progress and completion of the job according to the job object.

In some embodiments, in step (b), the base server specifies a server list of all servers to which media content is to be streamed as a part of the job object created. Also, in (d) following creation of a job object at the base server, the base server may transmit the job object to at least a first one of the node servers, and then stream the job content to the first node server The base server may also transmit the job object to plural ones of the node servers, and stream the job content to the plural node servers.

In a preferred embodiment a first node server, having received the job object and streaming job content, becomes a source server, and transmits the job object and streams the job content to further ones of the node servers.

In some cases a first node server having the job object attempts to stream the job content to a second node server already receiving streaming job content from a third node server. In this case the second node server may select between the first and third node servers for receiving streaming job content according to which of the first and third node servers can transmit at a higher rate.

In alternative embodiments the client content provider, having established a first job object at the base server and having begun streaming job content to the base server, may establish a second job object at the base server for distributing second streamed job content to the node servers. There may also be plural client content providers, and steps for the base server establishing job objects for individual ones of the plural client content providers and streaming job content for plural job objects to plural downstream nodes simultaneously.

In some embodiments of the method there steps for notification of completion by each node server associated with a job as each node server completes the job being passed to the base server, and the base server updating the client content provider of progress made. After all node servers have completed a job and have reported to the base server, the base server closes the associated job object and updates the client content provider associated with the job object.

In some embodiments, if the base server tracking completion of the job by the matrix of node servers notes the job is not completed by all node servers within a set time, the base server queries the node server or servers failing to complete. The base server may also attempt to repair failing node servers.

In embodiments of the present invention, taught in enabling detail below, for the first time an efficient streaming distribution system is provided for streaming media from content providers to multiple Internet-connected servers.

### BRIEF DESCRIPTION OF THE DRAWING FIGURES

FIG. 1 is an overview of a media-distribution system practiced on a DPN according to an embodiment of the present invention.

FIG. 2 is a block diagram illustrating components of a job object according to an embodiment of the present invention.

FIGS. 3-8 are block diagrams illustrating job/command distribution and notification levels according to an embodiment of the present invention.

FIG. 9 is a block diagram illustrating a job end notification according to an embodiment of the present invention.

FIG. 10 is a block diagram illustrating an incomplete job completion notification according to an embodiment of the present invention.

FIG. 11 is a block diagram illustrating a server recovery and reactivation protocol according to an embodiment of the present invention.

### DESCRIPTION OF THE PREFERRED EMBODIMENTS

According to a preferred embodiment of the present invention a streaming media-distribution system is provided for distributing streaming multimedia content and server commands to a plurality of distributed media servers.

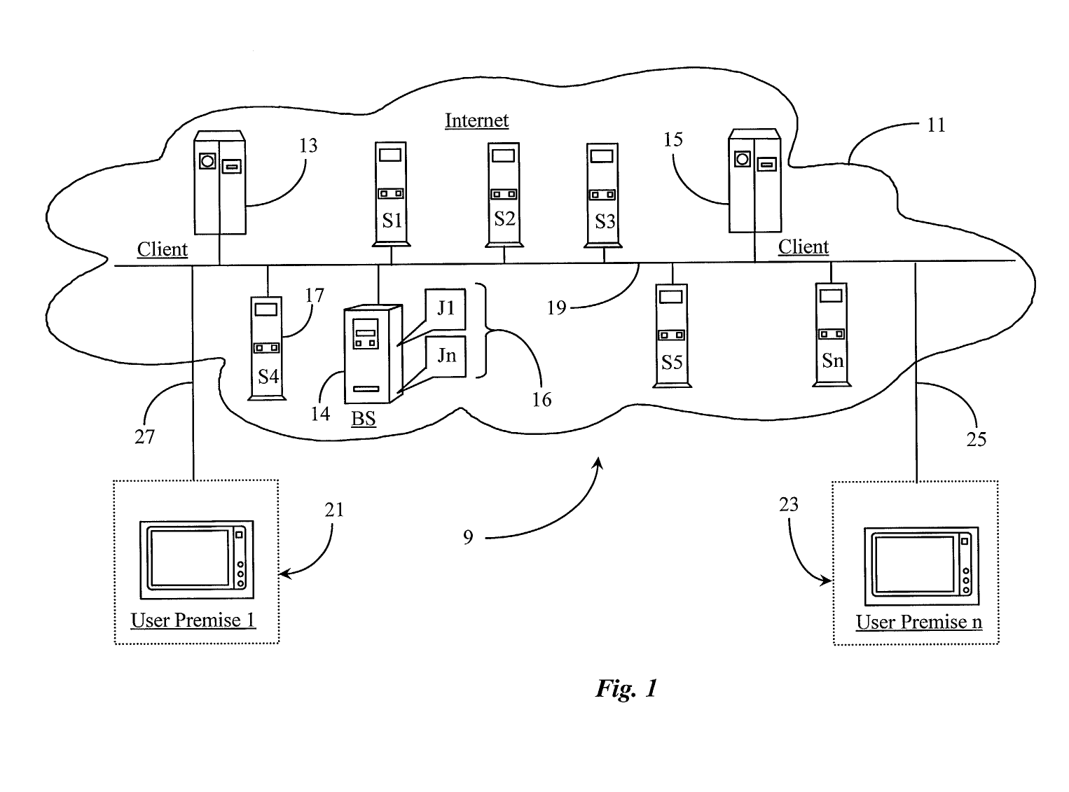

FIG. 1 is an overview of a streaming media-distribution system 9 practiced on DPN 11 according to an embodiment of the present invention. Media-distribution system 9 is practiced, in this example, on the well-known Internet network, which is a DPN and will hereinafter be referred to as Internet 11. Any other DPN may be used in place of or in combination with Internet 11 to practice the present invention. The inventor chooses the Internet network because of its high public-access characteristic.

An Internet backbone 19 is illustrated within Internet 11 and represents all of the lines and connection points making up the Internet network in a global sense. Therefore, there are no geographic limits for practicing the present invention. Furthermore, sub-nets connected to Internet 11 may be included in the scope of media-distribution system 9.

A client station 13 is provided within Internet 11 and illustrated as connected to backbone 19. Client station 13 represents any computer-enabled entity connected to Internet 11 that functions as a source for distributing streaming media content over Internet 11. Client 13 may be a server capable of issuing pre-programmed commands and initiating timed distribution of streaming media content.

In another embodiment, client 13 may be a manned computer node or system of nodes adapted for streaming media and server-command distribution. In this case, client 13 is within Internet 11 and is presumed to be an ever-connected part of Internet 11. However, client 13 may be a remote station that connects to Internet 11 through dial-up means or other means known in the art for accessing the Internet.

A second client station 15 is provided within Internet 11 and is illustrated as connected to backbone 19. Client 15 may be assumed to posses all of the attributes which were described above concerning client 13. It is noted here that clients 13 and 15 may differ from each other within the range of the description of client 13, which also applies equally to client 15.

A base station (BS) 14 is provided within Internet 11 and illustrated as connected to backbone 19. BS 14 is enabled as a main or controlling central server that functions as an interface between clients 13 and 15 and a plurality of end servers (S1-Sn) illustrated as distributed within Internet 11 and connected to backbone 19. Servers S1-Sn are enabled as media servers that are capable of delivering streaming media to end users as well as being adapted for receiving and distributing streaming media from and to other like media servers provided within Internet 11 (individual ones of S1-Sn). Servers S1-Sn are slaved to BS 14 in a preferred embodiment such that they may be controlled in some instances by BS 14. However, servers S1-Sn may also function independently from BS 14 according to a media-distribution protocol practiced on network 9.

It will be apparent to one with skill in the art that there may be any number of servers S1-Sn distributed within network 9 than are physically illustrated in this example without departing from the spirit and scope of the present invention.

A user premise 21, also labeled as user premise 1, is illustrated as connected to network 9 within Internet 11 by virtue of an Internet access line 27. Premise 21 is adapted, as illustrated by a monitor-display icon included therein, for connecting to Internet backbone 19 and communicating with any one of servers S1-Sn for the purpose of downloading streaming media content. Internet access line 27 represents any known means for Internet access. Examples include but are not limited to dial-up services as offered through an Internet Service Provider (ISP), cable/modem service, wireless satellite connection, and so on. In the case of a land-line connection, an ISP and telephone network are not illustrated for the purpose of simplicity, but they may be assumed to be present. In the case of a wireless access means, a wireless network is not illustrated for the same reasons described above, but may be assumed to be present.

A user premise 23, also labeled as user premise n, is illustrated as connected to network 9 within Internet 11 by virtue of an Internet access line 25. User premise 23 is adapted for communicating with and receiving media content from any one of servers S1-Sn as was described with user premise 21. Internet access line 25 represents any known means of Internet access as described with line 27. It will be appreciated by one with skill in the art that there may be many more user premises connected to backbone and communicating with servers S1-Sn than are physically illustrated in this example without departing from the spirit and scope of the present invention.

An object of the present invention is to provide a distribution network (9) wherein streaming media may be distributed by a client (13, 15) to end nodes (S1-Sn) in a more efficient and accountable fashion than is available in prior art systems. To accomplish this object the inventor provides a software component termed a Job object, two of which, J1 and Jn, are illustrated as executing on BS 14 in FIG. 1, collectively labeled with the element number 16. A job object 16 defines a job for distributing media to one or more of servers S1-Sn. One job object 16 is created for every media-distribution task defined and initiated by a client (13, 15). In this example, J1 may represent a job initiated by client 13 and Jn may represent a job initiated by client 15. Job objects 16 are created on BS 14 in response to client initiation of a job for media distribution to one or more of servers S1 Sn.

Job objects 16 are, in a preferred embodiment, Java-based, executable program-lists that provide instruction to servers S1-Sn for handling and redistributing streaming media. It is noted herein that any participating node must support the protocols of the system and must understand and be able to work with job objects, which function is provided by software executing on each such node. Each job object is unique to a client and a job the client wishes to accomplish. More detail about job objects is provided further below.

In practice of the present invention, a client, say client 13 for example, contacts BS 14 to establish a “job-distribution session”. BS 14 creates a job object, object 1 for example, on behalf of client 13. Job object 1 is a software entity and contains all of the data required to facilitate a job along with a list of servers among servers S1-Sn for data and command distribution during a job. Client 13 remains connected to BS 14 during job and command distribution and processing and may add commands to the job as distribution proceeds through network 9.

The method of distribution is such that the job object carries command instruction along with streaming media content, which is distributed to at least a first server, say server S1 for exemplary purposes. Server S1 then attempts to distribute the job object and the media content to other servers listed in the job object. Secondary servers then distribute to third-layer servers and so on until all of the servers listed in job object 1 receive their jobs instructions and media content.

As each server S1-Sn receives instruction and content, they are transformed into source servers that continue distribution. As each server completes a job, which includes distribution to still more servers (if listed), it sends notification thereof back to BS 14. When a client is finished with a job session, the session may be terminated with BS 14. However, BS 14 will continue to monitor job progress until all of the servers have responded with job-completion command receipt notification and have actually completed all of their job processes. At close, each server will respond back to BS 14 that a particular job is completely executed. Any server that does not report back to BS 14 at the close of a job may be queried by BS 14 as to current status. If a server has malfunctioned, then repair may be effected to the malfunctioning server by BS 14.

By practicing the present invention, which includes observance of various protocols, which are described below, a client may accomplish streaming of media content to a plurality of end servers in an optimized fashion where transfer rates are concerned and may also recover services of end servers that have malfunctioned under certain circumstances.

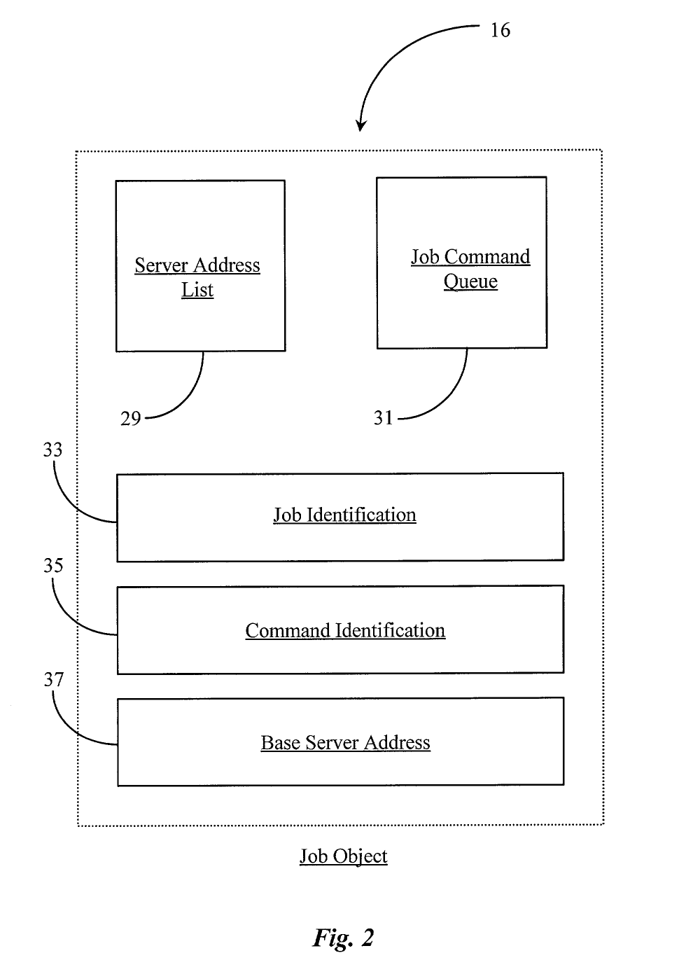

FIG. 2 is a block diagram illustrating components of job object (16) of FIG. 1 according to an embodiment of the present invention. Job object 16, further defined by plural objects J1-Jn of FIG. 1, has a server address list 29 incorporated therein and adapted to include server addresses of all of the target end-servers that media will be streamed to. A server address defines a permanent network location for a server.

A job command queue 31 is provided within object 16 and is adapted to contain commands issued by a client for furthering the distribution process. Queue 31 may be added to in the field while a distribution process is active by virtue of an open and active session established between a client and a BS. Commands are distributed to end servers in the same way that the job objects are distributed.

Object 16 also has a job identification field 33 provided therein and adapted to contain a job identification number or name, which specifically identifies the job and the client, and is unique to a client. A command identification field is provided within object 35 and adapted to contain command ID numbers specific to commands contained in queue 31. Object 16 also contains a base server address field 37 adapted to contain the address of the originating BS for notification purposes.

As described with reference to FIG. 1, job objects 16 are created at BS 14 on behalf of clients 13 and 15, also of FIG. 1. Referring back to FIG. 1 for exemplary purpose, client 15 sends a request to BS 14 to initiate a media-distribution job. BS 14 may either accept or deny the request. If the request is accepted, BS 14 creates job object 16 and assigns a unique job identification number represented in FIG. 2 by element 33. BS 14 also provides a list of all of the participating servers present on network 9 (FIG. 1). The aforementioned information, field value 33 and list 29, is then sent back to client 15. BS 14 then idles in session waiting to receive commands from client 15. Such commands may originate at client 15 if it is a manned station, or may come from a remote user connected to client 15 if it is an unmanned server.

Commands and associated data are sent to queue 31 from client 15 using a Command Transfer Protocol (CTP), which is similar to File Transfer Protocol (FTP), a well-known and commonly used data transfer protocol. It is noted herein that a command may not necessarily accompany data. This protocol allows, among other things, controlled file uploads and downloads between servers. The protocol also insures that file attributes are copied. Other attributes of CTP include the ability to browse a remote directory and enumerate sub-directories and existing files located in them. It is also possible with CTP to obtain file and directory properties from specific files and directories found on remote servers, and to change such properties. New files and directories may also be created using CTP.

It is noted herein that each distributed command coming from a client has three operative states. These are new (pending execution), in progress (currently being executed), and completed (finished executing). More detail about distributing commands is provided in the FIGS. below.

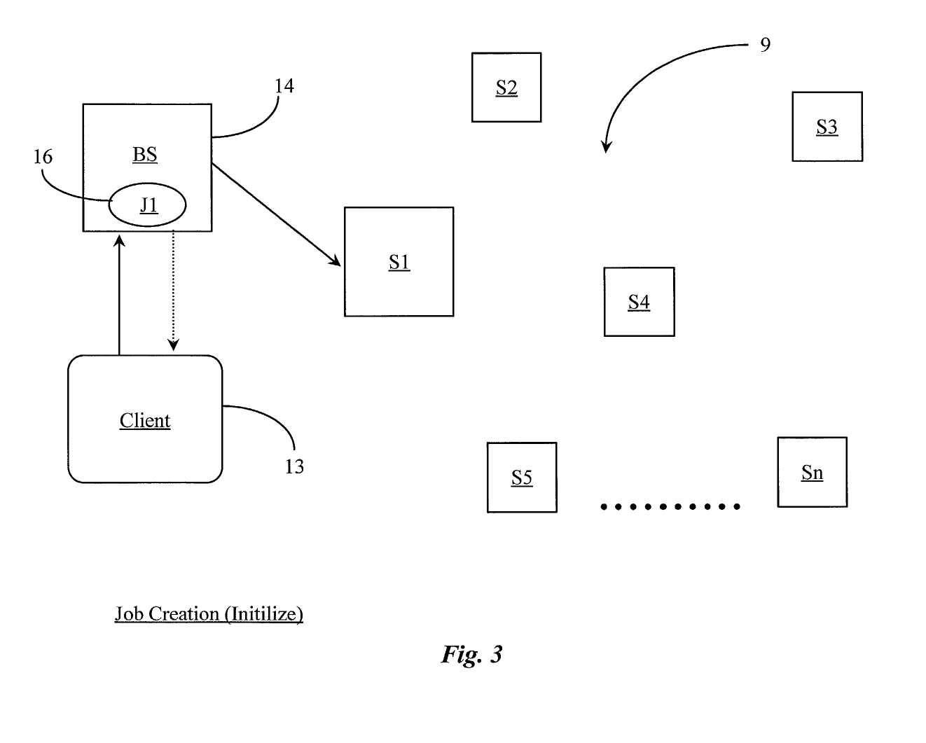

FIGS. 3-8 are block diagrams illustrating job/command distribution and notification levels according to an embodiment of the present invention. Referring now to FIG. 3, client 13 has requested and been granted a session with BS 14, and job object 16 has been created. This is now Job 1 (J1). The session request is illustrated herein by a directional arrow leading from client 13 and progressing to BS 14. A job ID and server list is sent back to client 13 after job object 16 is created as illustrated by a dotted directional arrow leading from BS 14 and progressing toward client 13. In this example, S1 is the first server to which information and media will be distributed as illustrated by a directional arrow leading from BS 14 to S1.

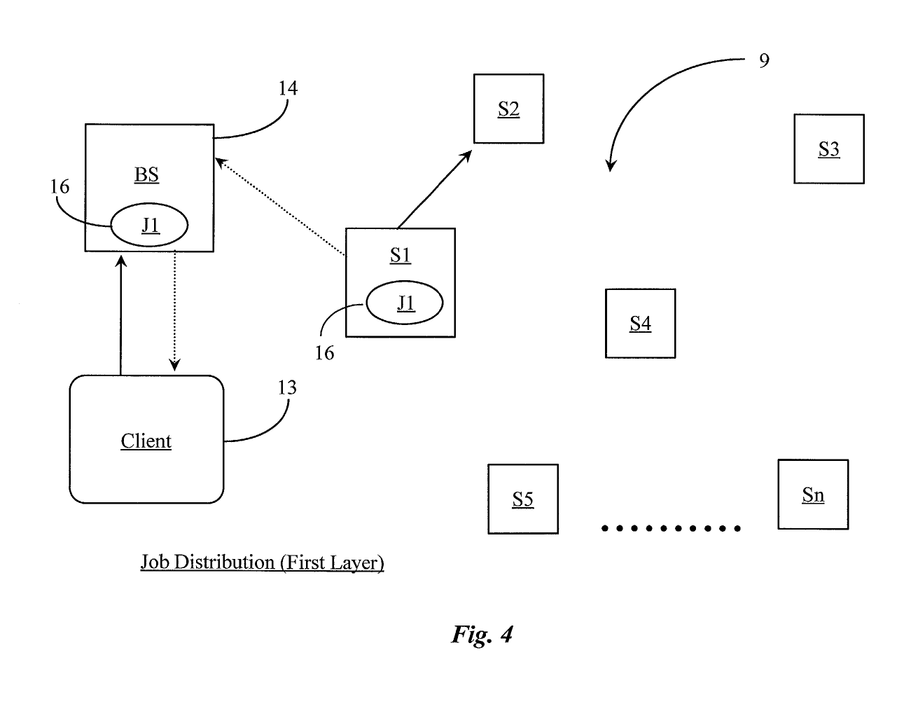

Referring now to FIG. 4, it is noted that S1 now has a copy of J1 (16) that it has received from BS 14. This includes any commands sent to BS14 in the interim. Such commands are held in queue 31 of FIG. 2 as previously described. S1, upon receiving the job information, commands and media from BS 14, sends notification (illustrated by a dotted directional arrow) back to BS14. At this point, notification information is passed back to client 13 (dotted arrow between BS 14 and client 13). If server S1 is the only server in list 29 (FIG. 2), then it may complete its function without further distribution. In actual practice, however, there will likely be many more down-line servers to which data and media will be distributed.

To illustrate a command notification, assume that client 13 has added a new command to command queue 31 in J1, and that command is distributed to S1 and is logged into command queue 31 at S1. The command state is set to new and does not change until S1 begins execution of the command. Therefore, there are three notifications that may be sent back to BS14 and ultimately to client 13. The first notification is that S1 received the new command. The second notification is that S1 is executing the command. The third notification is that S1 has completed execution of the command. All three notification states may be represented by the dotted directional arrows leading from S1 back to client 13. However, the first two notifications are solicited, in preferred embodiments, by query if the information is desired. The final notification (completion) is automatic every time a command is completely executed. S1 is in this example distributing job information (J1). Subsequent commands concerning J1, which are sent by client 13, are distributed in the same fashion as job information.

In this example, S1 attempts to distribute job information to S2, which is included in server address list 29 (FIG. 2). It is noted herein that S1 may attempt to distribute to more than one listed server simultaneously. For exemplary purposes however, S1 is illustrated as attempting to distribute only to S2.

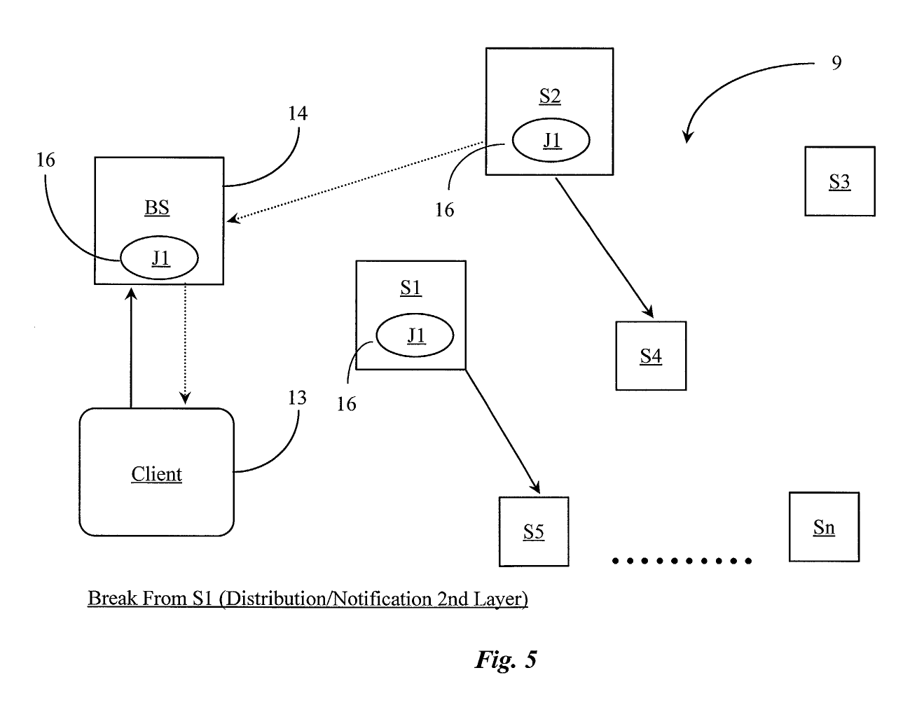

Referring now to FIG. 5, S2 now has J1 from S1 and breaks connection with S1. In this case, both S1 and S2 are now source servers, who attempt to further distribute media and command information to subsequent servers. S2 sends job receipt notification back to BS 14 as illustrated by the dotted directional arrow leading from S2 back to BS14. BS14 passes the information back to client 13 as illustrated by the dotted directional arrow leading from BS14 back to client 13. S1 is now attempting distribute job information to S5, which is included in field 29 (FIG. 2). S2 is attempting to distribute to S4 representing distribution and notification at a 2^{nd} layer. It is important to note herein that automatic notifications may only comprise job receipt notifications and command completion notifications. However, other types of status notifications may be made automatic by programming if so desired.

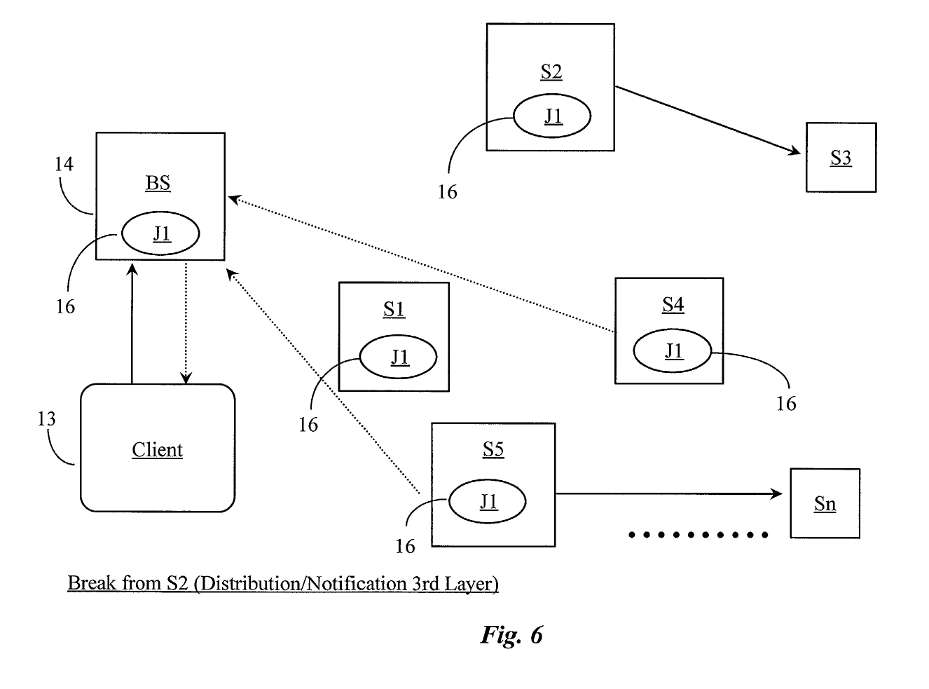

Referring now to FIG. 6, S4 and S5 have received job information from S2 and S1 respectively. S4 and S5 send notification directly to BS14 as illustrated by the dotted directional arrows leading from both S4 and S5 and progressing toward BS14. Notification is then passed to client 13 as previously described. S1, S2, S4, and S5 are now all source servers attempting to distribute information to other servers on list 29 (FIG. 2), if any.

It is illustrated in this example that S2 is attempting to distribute job information to S3 and S5 is attempting to distribute job information to Sn as illustrated by a directional arrows, one leading from S2 and progressing toward S3 and one leading from S5 and progressing toward Sn. This represents third layer distribution and notification. Each time a participating server receives job information and subsequent commands, it sends notification thereof back to BS 14.

It will be apparent to one with skill in the art that the distribution protocol of attempting to distribute to all down-line servers, and the function of breaking connection with BS 14 to act as a new source server, causes distribution frequency to increase exponentially with greater numbers of participating servers. As previously described, commands are distributed in the same manner as job information and are processed by each receiving server with that server attempting to distribute the same command to all of the other servers on list 29 (FIG. 2).

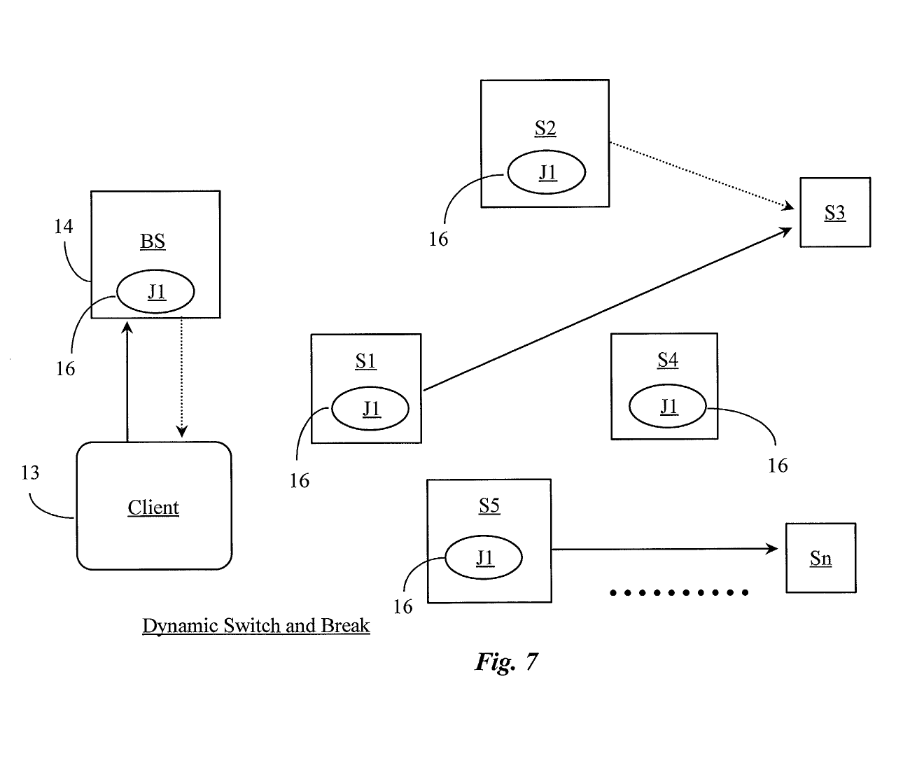

Referring now to FIG. 7, S1 attempts to distribute information to S3 as illustrated by a directional arrow leading from S1 and progressing toward S3. However, S3 is currently receiving the same information from S2 as illustrated by a dotted directional arrow leading from S2 and progressing toward S3. In this case, a dynamic switch may occur if it is determined by S3 that S1 has a faster data transfer rate than S2. Dynamic Switching Optimization (DSO) allows a receiving server to switch to another sending server attempting to send data if the alternative sending server transfers at a higher data rate. Assuming this is the case, S1 will take over the data transfer at the point where S2 left off and S2 will move on to attempt distribution to a next server. More about this and other optimization techniques is detailed later in this specification.

S4 is idle in this example meaning that it has not attempted to distribute its job information or media to any other servers. This may be due to an error or malfunction in server hardware or software. A recovery technique for querying status of S4 and recovering its services before or after termination of a media-distribution job is described further below.

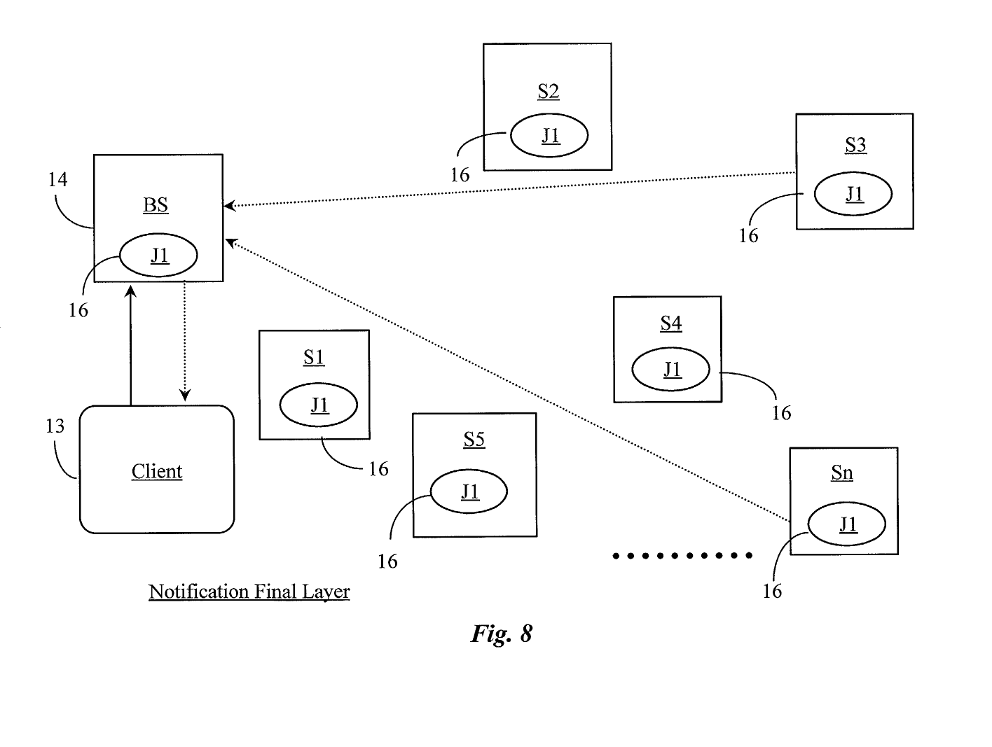

Referring now to FIG. 8, S3, and Sn have received job information from S1 and S5 respectively, and send notifications thereof to BS14 as illustrated by dotted directional arrows, one leading from S3 and progressing toward BS14, and one leading from Sn and progressing toward BS14. This represents a state wherein all servers on list 29 (FIG. 2) have received job information and final notifications are arriving to BS14. Again, commands are propagated in the same fashion, and notification of completed commands are sent back to BS 14 directly from executing servers. After all of the target servers receive and execute all commands and distribute their media, final completion notifications are sent to BS14 from participating servers. This occurs after client 13 has sent end-job commands as further described below.

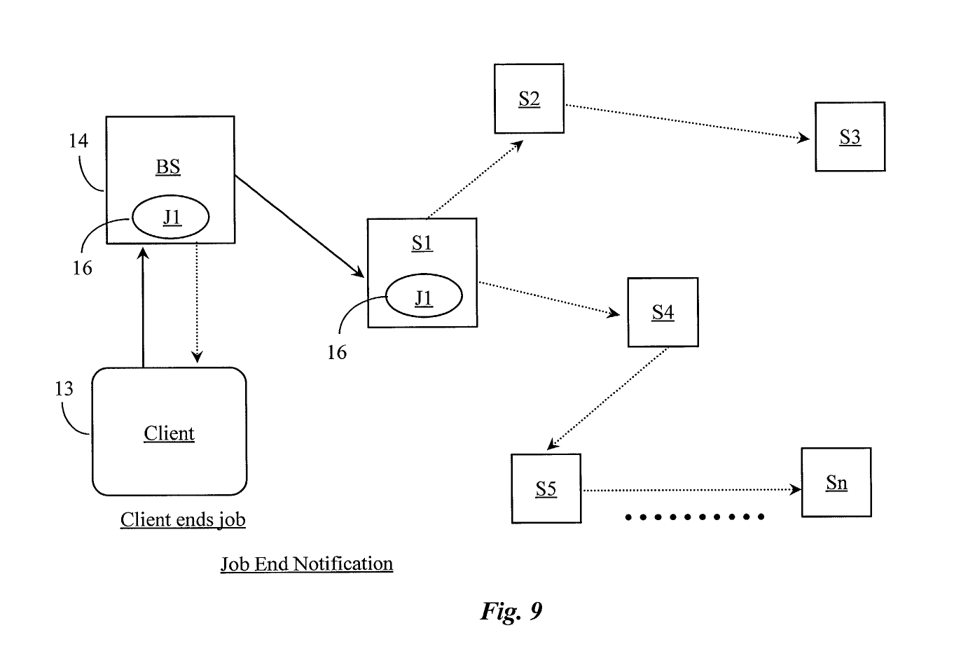

FIG. 9 is a block diagram illustrating a job end notification according to an embodiment of the present invention. In this example, it is assumed that all job information and commands have been distributed to all of the participating servers S1-Sn. At this point, a client sends notification of ending a job as illustrated by a directional arrow leading from client 13 and progressing toward BS14. The end-job command is distributed to the first server (S1) and subsequently distributed to all of the other servers as logically illustrated by dotted directional arrows connecting the servers. In actual practice, servers will break off and become source servers and attempt to distribute notification to all of the other servers in the same manners as described above, including dynamic switching where appropriate.

At this point, client 13 will end session with BS 14. However BS 14 must wait for all notification to come in from all of the affected servers regarding completion of their functions defined by successful execution of all of their remaining commands. Optimization protocols are provided by the inventor to optimize command and data distribution. These protocols are listed as follows:

1) Command Propagation Optimization:

Whenever a server propagates a command, a list of indexes is also sent to the destination server for that command. Each index value in the list points to a server in the server list, that was passed to a target server during Job creation. These are servers that were not approached by a source server for propagation of a command untill that time. The target server will try to distribute the command only to these servers in list.

2) Multiple Node Handling:

A Server may open connections with multiple down-line servers to distribute the streaming media content and commands. It may process these connections simultaneously. The number of down-line servers it negotiates with may be governed by a number of factors, like optimum use of available bandwidth, processing power and system wide resources.

3) Data Rate Sort Order:

Each server may sort its list of servers in descending order of the data-upload rate they support. Thus, the servers will now be addressed in the descending order of their upload data rates. It is noted herein that this may not always be the fastest way of carrying out the media distribution process from the point of view the overall system. However, sorting by data rate will, in most cases, achieve a better efficiency for the system overall, when compared to a random selection of servers from the list.

Dynamic Switching:

Whenever a server with a Job ID and a command ID requests services with a subsequent server for the purpose of distributing streaming media content and commands, it will also inform the receiving server of the data rate that it can support for the current transfer. This mechanism comes into play when that command ID is already being served at the destination server by another server in the system. The destination server can compare the data rate supported by the current source server with the data rate of the requesting server, which proposes to serve the same data. In a case wherein better efficiency may be achieved with the requesting server, the destination server can dynamically switch to the new server.

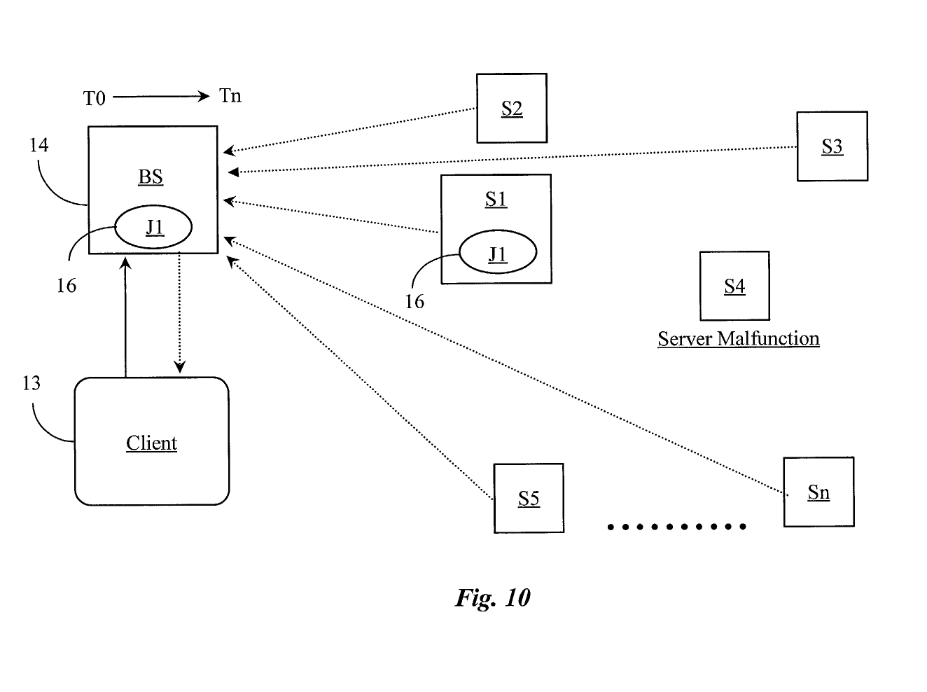

FIG. 10 is a block diagram illustrating an incomplete job completion notification according to an embodiment of the present invention. In this example, client 13 has sent an end job command as illustrated in FIG. 9 and has now quit its session with BS 14 and is no longer connected. However, BS14 is still receiving final notifications from servers S1, S2, S3, S5, and Sn. This process occurs during a wait period illustrated herein as a time period from T0 to Tn illustrated immediately above BS14. It is noted herein that during time period T0 to Tn, that server S4 has not reported back that it has completed its stated function. It may be that S4 is still processing final commands. It may be that server S4 is malfunctioning as illustrated in this example. Even though client 13 is no longer in session with B.S 14, BS14 will call client 13 to give final notification status after all servers have reported back.

Before final notification is sent to client 13, BS14 will query the status of S4 in an attempt to determine its operating status. If a status report indicates that final commands are still in progress or new and not yet in progress, then wait period T0 to Tn will be extended for another unit of time. If S4 completes execution and notification within the extended period, then BS14 will declare the job completed and will notify client 13. It is noted herein that in some cases this process may take more than one or two wait periods. If there is no response or there is an error response sent by S4 as a result of a status query sent by BS14, then it may be inferred that there is an application error that has occurred or is occurring either before or during execution or, that S4 is unavailable or off-line due to hardware malfunction.

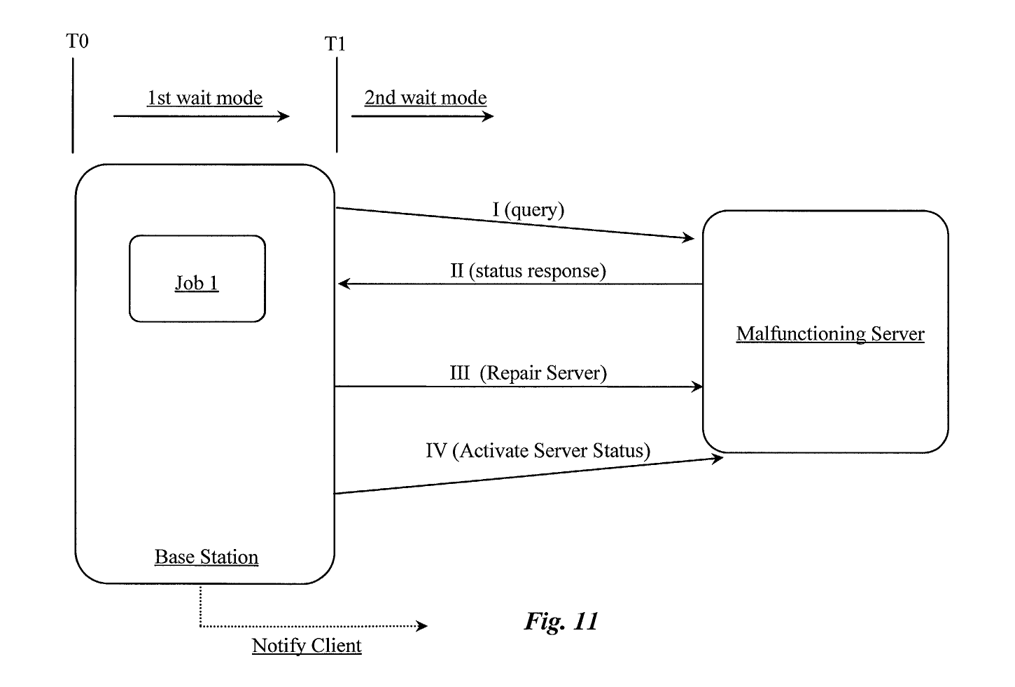

FIG. 11 is a block diagram illustrating a server recovery and reactivation protocol according to an embodiment of the present invention. In this example it is assumed that S4 of FIG. 10 was malfunctioning and did not respond with completion notification during T0 to T1 (1^{st} wait mode). A status query illustrated by a directional arrow labeled I (query) is sent to S4 by BS14 during a second wait mode. S4 responds with an error notification illustrated as a directional arrow labeled II (status response). Assuming that response II indicates an on-line status but failing in final execution of a command or commands, an attempt to repair S4 is initiated by BS14 as illustrated by a directional arrow labeled III (Repair Server). A subsequent initiated communication from BS 14 attempts to recover services as illustrated by a directional arrow labeled IV (Activate Server Status).

If S4 is successfully reactivated, then it may proceed to complete its function and send final notification thereof back to BS 14 during an extended wait time. Once finished, BS14 will officially close the job and send final notification back to client 13 as illustrated by the dotted directional arrow labeled notify client. In some cases, such as hardware failure or the like, BS14 may notify client 13 of the situation and an expected wait period for bringing server S4 back on-line.

It will be apparent to one with skill in the art that the various configurations illustrated above with respect to FIGS. 3-11 represent very simple example-states only. In actual practice of the present invention, base to server, server to server, and server to base transactions occur at a rapid rate according to all of the optimization rules described above. Further, although various states for propagation of a single job object have been described in detail, it is not necessary that a first job be completed and verified before a second job object is created and begins propagation. Such as second, and subsequent jobs may initiate with client 13, client 15, or any other client in the system.

It will also be apparent to one with skill in the art that the method and apparatus of the present invention may be practiced on the Internet network, an Intranet network, or any other DPN adapted to support the required protocols without departing from the spirit and scope of the present invention. Therefore, the methods and apparatus of the present invention should be afforded the broadest possible scope. The spirit and scope of the present invention is limited only by the claims that follow.

What is claimed is:

1. A system for efficient streaming of media content from a client content provider to individual Internet destinations, comprising:
an Internet-connected base server for job initialization and tracking; and
a matrix of Internet-connected node servers, at least some of which are to receive the streaming media content;
characterized in that the client, the base station and the node servers each execute cooperative software, wherein a client requests a job session of the base server, specifying dimensions of the job, and the base server creates a unique job object defining the job, receives the streaming content from the client, governs distribution of the streaming content to the matrix of node servers according to the job object, and notifies the client content provider of progress and completion.

2. The system of claim 1 wherein the base server specifies a server list of all servers to which media content is to be streamed as a part of the job object created.

3. The system of claim 1 wherein, following creation of a job object at the base server, the base server transmits the job object to at least a first one of the node servers, and then streams the job content to the first node server

4. The system of claim 3 wherein the base server transmits the job object to plural ones of the node servers, and streams the job content to the plural node servers.

5. The system of claim 3 wherein the first node server, having received the job object, becomes a source server, and transmits the job object and streams the job content to further ones of the node servers.

6. The system of claim 5 wherein a first node server having the job object attempts to stream the job content to a second node server already receiving streaming job content from a third node server, and the second node server selects between the first and third node servers for receiving streaming job content according to which of the first and third node servers can transmit at a higher rate.

7. The system of claim 1 wherein the client content provider, having established a first job object at the base server and having begun streaming job content to the base server, establishes a second job object at the base server for distributing second streamed job content to the node servers.

8. The system of claim 1 further comprising plural client content providers, wherein the base server establishes job objects for individual ones of the plural client content providers and streams job content for plural job objects to plural downstream nodes simultaneously.

9. The system of claim 1 wherein, as each node server completes a job, notification of completion is passed to the base server, which updates the client content provider of progress made.

10. The system of claim 9 wherein, after all node servers have completed a job and have reported to the base server, the base server closes the associated job object and updates the client content provider associated with the job object.

11. The system of claim 9, wherein the base server tracks completion of the job by the matrix of node servers, and if the job is not completed by all node servers within a set time, the base server queries the node server or servers failing to complete.

12. The system of claim 11 wherein the base server, receiving no response from a node server, attempts to repair the node server not responding.

13. A method for efficient streaming of media content from a client content provider to individual Internet destinations, comprising steps of:
(a) requesting, by the client content provider of a base server, creation of a job object defining the job by dimensions supplied by the client content provider;
(b) creation, by the base server, the job object requested;
(c) receiving, by the base server, streaming job content from the client content provider according to the job object;
(d) distributing, by the base server, the job object and streaming job content to individual ones of plural node servers at the Internet destinations; and
(e) notifying the client content provider, by the base server, of progress and completion of the job according to the job object.

14. The method of claim 13 wherein, in step (b), the base server specifies a server list of all servers to which media content is to be streamed as a part of the job object created.

15. The method of claim 13 wherein, in step (d) following creation of a job object at the base server, the base server transmits the job object to at least a first one of the node servers, and then streams the job content to the first node server

16. The method of claim 15 wherein, in step (d), the base server transmits the job object to plural ones of the node servers, and streams the job content to the plural node servers.

17. The method of claim 15 further comprising a step for the first node server, having received the job object, becomes a source server, and transmits the job object and streams the job content to further ones of the node servers.

18. The method of claim 17 wherein a first node server having the job object attempts to stream the job content to a second node server already receiving streaming job content from a third node server, and further comprising a step for the second node server selecting between the first and third node servers for receiving streaming job content according to which of the first and third node servers can transmit at a higher rate.

19. The method of claim 13 further comprising steps for the client content provider, having established a first job object at the base server and having begun streaming job content to the base server, establishing a second job object at the base server for distributing second streamed job content to the node servers.

20. The method of claim 13 further comprising plural client content providers, and further comprising steps for the base server establishing job objects for individual ones of the plural client content providers and streaming job content for plural job objects to plural downstream nodes simultaneously.

21. The method of claim 13 further comprising steps for notification of completion by each node server associated with a job as each node server completes the job being passed to the base server, and the base server updating the client content provider of progress made.

22. The method of claim 21 further comprising a step for, after all node servers have completed a job and have reported to the base server, the base server closing the associated job object and updating the client content provider associated with the job object.

23. The method of claim 21 further comprising a step for the base server tracking completion of the job by the matrix of node servers, and if the job is not completed by all node servers within a set time, the base server querying the node server or servers failing to complete.

24. The method of claim 23 further comprising a step for the base server, receiving no response from a node server, attempting to repair the node server not responding.
